(19) United States
(12) Patent Application Publication
(10) Pub. No.: US 2026/0252295 A1
(43) Pub. Date: Aug. 27, 2026

(54) TRANSMISSION METHOD FOR DISPLAY DATA AND ELECTRONIC DEVICE

(71) Applicant: SPREADTRUM SEMICONDUCTOR (CHENGDU) CO., LTD., Chengdu, Sichuan (CN)

(72) Inventors: Zhiwei WANG, Chengdu (CN); Chen HE, Chengdu (CN)

(21) Appl. No.: 18/872,535

(22) PCT Filed: Jun. 9, 2023
(86) PCT No.: PCT/CN2023/099506

§ 371 Date: Dec. 6, 2024

(30) Foreign Application Priority Data
Jun. 10, 2022 (CN) 202210655509.4

(51) Int. Cl. G06F 3/14; G06F 1/16; G09G 5/00

(52) U.S. Cl. CPC G06F 3/1438; G06F 1/1677; G06F 3/1407; G09G 5/005; G09G 2330/021; G09G 2340/0435

(57) ABSTRACT

Disclosed are a transmission method for display data, an electronic device, and a module device, which relate to the technical field of screens. The method includes sending a display signal. The display signal includes multiple types of display sub-signals, each display sub-signal of each type of display sub-signal includes a first part and a second part, first parts of different types of display sub-signals are display data for the same display unit, and second parts of different types of display sub-signals are display data for different display units.

### CROSS-REFERENCE TO RELATED APPLICATION(S)

This application is a National Stage of International Application No. PCT/CN2023/099506, field Jun. 9, 2023, which claims priority to Chinese Patent Application No. 202210655509.4, filed Jun. 10, 2022, the entire disclosures of which are incorporated herein by reference in their entireties.

### TECHNICAL FIELD

This disclosure relates to the field of screen technology, and in particular, to a transmission method for display data, an electronic device, and a module device

### BACKGROUND

With the development of electronic technologies, the number of screens used in a smart cabin of a vehicle is increasing. Exemplarily, the vehicle may include multiple screens such as a dashboard screen, a head-up display (HUD) screen, a central control screen, a front-passenger screen, and a rear-seat screen.

In general, images displayed on the multiple screens in the vehicle are generated by a display chip of the vehicle. Since the number of display interfaces of the display chip is usually limited, the display interfaces is extended by using field programmable gate array (FPGA) technology, flat panel display link (FPD-LINK) technology, or the like. However, with the increasing requirement on the number of screens and the limited processing capability of the chip in the smart cabin scenario, the multi-screen requirement of the smart cabin may be not met by using FPGA technology and FPD-LINK technology.

### SUMMARY

In a first aspect, a transmission method for display data is provided in the present disclosure. A display signal is sent. The display signal includes multiple types of display sub-signals, each display sub-signal of each type of display sub-signal includes a first part and a second part, first parts of different types of display sub-signals are display data for the same display unit, and second parts of different types of display sub-signals are display data for different display units.

In a second aspect, a transmission method for display data is provided in the present disclosure. A display signal is sent. The display signal contains display data for at least one display unit, the display data for the at least one display unit is folded display data, and a product of a fold parameter of horizontal pixels of the display data and a fold parameter of vertical pixels of the display data is 1.

In a third aspect, an electronic device is provided in embodiments of the present disclosure. The electronic device includes a processor and a memory, where the memory is configured to store a computer program, and the processor is configured to invoke the computer program from the memory to make the electronic device execute the method execute the method in the first aspect or any one possible embodiment of the first aspect, or execute the method in the second aspect or any one possible embodiment of the second aspect.

### BRIEF DESCRIPTION OF THE DRAWINGS

FIG. 1 is a schematic structural diagram of a multi-screen display system provided in an embodiment of the present disclosure.

FIG. 2 is a flowchart of a transmission method for display data provided in an embodiment of the present disclosure.

FIGS. 3-9 are schematic diagrams of a first type of display sub-signals and a second type of display sub-signals provided in an embodiment of the present disclosure.

FIG. 10 is a schematic diagram of a first type of display sub-signals, a second type of display sub-signals, a third type of display sub-signals, and a fourth type of display sub-signals provided in an embodiment of the present disclosure.

FIG. 11 is a schematic diagram of a first type of display sub-signals and a second type of display sub-signals provided in an embodiment of the present disclosure.

FIG. 12 is a schematic structural diagram of another multi-screen display system provided in an embodiment of the present disclosure.

FIG. 13 is a schematic diagram of output display data provided in an embodiment of the present disclosure.

FIG. 14 is a flow chart of a transmission method for display data provided in an embodiment of the present disclosure.

FIGS. 15-17 are schematic diagrams of a display signal provided in an embodiment of the present disclosure.

FIG. 18 is a schematic structural diagram of an electronic device provided in an embodiment of the present disclosure.

FIG. 19 is a schematic structural diagram of an electronic device provided in an embodiment of the present disclosure.

FIG. 20 is a schematic structural diagram of a chip provided in an embodiment of the present disclosure.

FIG. 21 is a schematic structural diagram of a chip module provided in an embodiment of the present disclosure.

### DETAILED DESCRIPTION

The technical solutions in embodiments of the present disclosure will be described in more detail below.

It may be also understood that, the terms used in implementations of the disclosure are merely intended for describing the implementations, rather than limiting implementations of the disclosure. For example, the singular form “a/an”, “a type of” “said”, “above”, and “the” used in the specification and the appended claims of the disclosure are also intended to include multiple forms, unless specified otherwise in the context. It may also be understood that the term “and/or” used in the disclosure refers to and includes any or all possible combinations of one or more listed items. It may also be understood that the term “multiple” or “a plurality of” used in the disclosure refers to two or more.

It may be noted that the terms “first”, “second”, “third”, and the like used in the specification, the claims, and the accompanying drawings of the disclosure are used to distinguish different objects rather than describe a particular order. It may be understood that the terms thus used may be interchangeable where appropriate, so that the implementations of the disclosure described herein, for example, can be implemented in a sequence other than those illustrated or described herein. In addition, the terms “include” and “comprise” as well as variations thereof are intended to cover a non-exclusive inclusion. For example, a process, method, system, product, or server including a series of operations or units is not limited to the listed operations or units, and instead, it can optionally include other operations or units that are not listed or other operations or units inherent to the process, method, product, or device.

In the description of the present disclosure, it is to be noted that, unless specified or limited otherwise, the terms “mounted”, “coupled”, and “connected” should be interpreted broadly, and may be, for example, fixed connection, detachable connection, or integral connection; may be mechanical connection, electrical connection, or communicating with each other; may be direct connection or indirect connection via an intermediate medium; may be inner communication of two elements or an interaction relationship between two elements. The specific meanings of the above terms in the present disclosure can be understood by those skilled in the art according to specific situations.

The multi-screen display system of the present disclosure can be applied to a smart cabin of a vehicle. Generally, images displayed on multiple screens in the vehicle are generated by a display chip of the vehicle. Exemplarily, the display chip may be a system on chip (SOC). Since the number of display interfaces of the display chip is usually limited, in most of current multi-screen extension solutions, the number of screens and resolutions corresponding to the screens that are supported are designed according to the maximum image resolution that can be supported by the display chip, and in this way, the number of screens or the resolution corresponding to the screens, that can be supported by the cabin, will be limited.

In view of this, technical solutions of embodiments of the present disclosure are proposed. In embodiments of the present disclosure, the display signal is designed, display data of various screens can be flexibly combined, so that the number of screens that can be supported by a multi-screen display system can be increased in the case that the maximum resolution supported by a processing unit of the multi-screen display system is fixed.

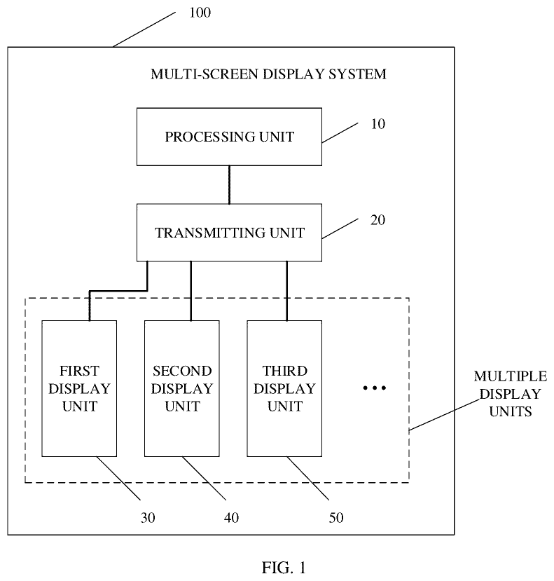

Reference is made to FIG. 1, which is a schematic structural diagram of a multi-screen display system provided in an embodiment of the present disclosure. Exemplarily, the multi-screen display system 100 includes a processing unit 10, a transmitting unit 20, and multiple display units. Exemplarily, the multiple display units include a first display unit 30, a second display unit 40, and a third display unit 50. It can be noted that the multi-screen display system can further include more display units, not all the display units are illustrated in the figure. Optionally, an operating system running in the multi-screen display system is not limited in embodiments of the present disclosure, and the operating system may be an Android system, a Linux system, a real time operating system (RTOS), or the like. The processing unit 10 is connected to the transmitting unit 20.

Optionally, the processing unit 10 and the transmitting unit 20 are connected through one or more interfaces, and the interface may be one of the following interfaces: a mobile industry processor interface-display serial interface (MIPI-DSI), a serial peripheral interface (SPI), a low-voltage differential signaling (LVDS) interface, and a high-definition digital interface (DP). In an application scenario, another type of interface may also exist, which is not limited in embodiments of the present disclosure.

The transmitting unit 20 is also connected to the multiple display units, and optionally, the transmitting unit 20 is connected to each of the multiple display units. As illustrated in FIG. 1, the transmitting unit 20 is connected with the first display unit 30, the second display unit 40, and the third display unit 50.

In some embodiments, the processing unit 10 may be the display chip described above. The processing unit 10 is configured to generate display data for the multiple display units in the multi-screen display system, and send the display data to the transmitting unit 20. The transmitting unit 20 is configured to send display data corresponding to each display unit to the multiple display units according to the display data. The multiple display units may be the screens described above. Optionally, the multiple display units are one or more of a dashboard screen, a center control screen, a head-up display (HUD) screen, a front-passenger screen, a rear-seat screen, an air conditioner screen, or the like.

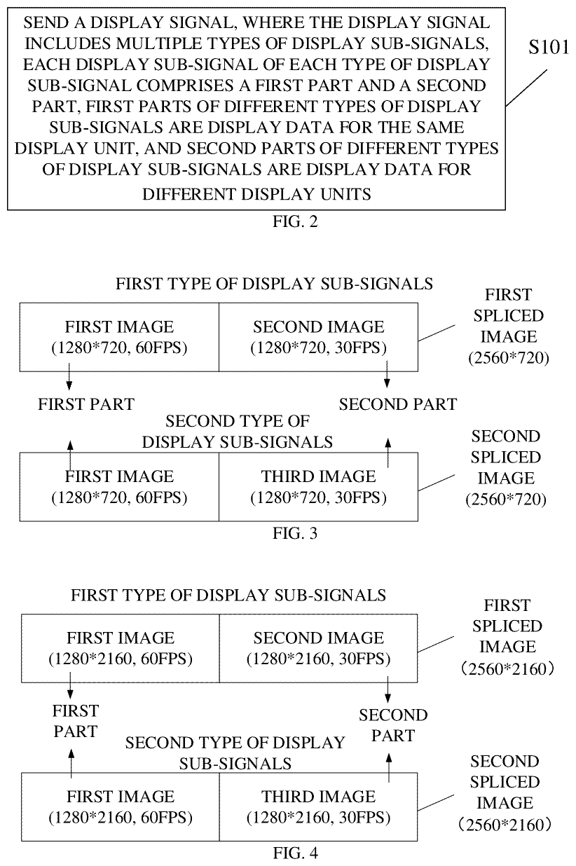

The solutions of the embodiments of the present disclosure will be further described hereinafter. FIG. 2 is a flowchart of a transmission method for display data provided in an embodiment of the present disclosure. The method may be applied to the multi-screen display system illustrated in FIG. 1, and the method may be performed by the processing unit in FIG. 1. The method includes the following operations.

At S101, a display signal is sent.

Optionally, the processing unit 10 generates and sends the display signal to the transmitting unit 20, where the display signal includes multiple types of display sub-signals. The multiple types of display sub-signals may be understood as two or more types of display sub-signals. Different display sub-signals are distinguished according to display units corresponding to display data contained in the display sub-signals (for ease of description, also referred to as display units corresponding to display sub-signals hereinafter). Exemplarily, a display sub-signal 1 contains display data for the first display unit 30 and display data for the second display unit 40, and a display sub-signal 2 contains display data for the first display unit 30 and display data for the third display unit 50, so that the display sub-signal 1 and the display sub-signal 2 are display sub-signals of different types. Exemplarily, a display sub-signal 3 contains display data for the first display unit 30 and display data for the second display unit 40, and a display sub-signal 4 contains display data for the first display unit 30 and display data for the second display unit 40, so that the display sub-signal 3 and the display sub-signal 4 are display sub-signals of the same type.

Each sub-signal of Each type of display sub-signal includes a first part and a second part, first parts of different types of display sub-signals are display data for the same display unit, and second parts of different types of display sub-signals are display data for different display units. In the process of sending display data, different types of display sub-signals may be sent successively, and display sub-signals sent at one time do not necessarily include display data for all display units at the same time, in other words, display data for various display units can be flexibly combined in the display signals, and in the case that the maximum resolution supported by the processing unit 10 is fixed, the number of screens that the processing unit 10 can support may be increased.

It can be noted that the same display unit may include one or more display units, and different display units may include one or more display units, and the number of display units corresponding to a display sub-signal is not limited in the present disclosure. The same display unit refers to a display unit corresponding to each type of display sub-signals, and part of display units corresponding to second parts of some display sub-signals may be the same. Exemplarily, a display sub-signal 5 corresponds to the first display unit 30, the second display unit 40, and the third display unit 50, a display sub-signal 6 corresponds to the first display unit 30, the second display unit 40, and a fourth display unit, and a display sub-signal 7 corresponds to the first display unit 30, a fifth display unit, and a sixth display unit. For these three types of display sub-signals, the same display unit is the first display unit 30, and the different display units includes the second display unit 40 and the third display unit, the second display unit 40 and the fourth display unit, and the fifth display unit and the sixth display unit. That is to say, first parts of display sub-signals are compared as a whole, and second parts of display sub-signals are compared as a whole.

In a possible embodiment, a frame rate of (each of) the same display unit(s) is greater than a frame rate of each of the different display units. A frame rate refers to a frequency (or referred to as a rate) at which bitmap images in units of frames continuously appear on a screen, and a unit of the frame rate is frames per second (fps). Generally, a higher frame rate leads to a smoother and more realistic image displayed on the screen. Different screens in the vehicle may have different display frame-rate requirements. Exemplarily, the frame rate required by the dashboard screen and the HUD screen in the smart cabin is 60 fps, and the frame rate required by the center control screen, the front-driving screen, the rear-seat screen, or the like is 30 fps. In order to ensure the display requirements of the high frame-rate display unit, first parts of all the multiple display sub-signals include display data for the high frame-rate display unit.

It can be noted that, in embodiments of the present disclosure, the design of the display sub-signals also needs to consider the maximum number of pixels of an image and the maximum frame rate that the processing unit 10 supports to process. In embodiments of the present disclosure, the maximum number of pixels of the image that the processing unit 10 supports to process is greater than the number of pixels of an image displayed by each display unit. Furthermore, the maximum number of pixels of the image that the processing unit 10 supports to process is greater than the number of pixels of display data contained in each display sub-signal. In addition, the maximum frame rate that the processing unit 10 supports to process is greater than or equal to the frame rate displayed by each display unit. There may be a difference in a frame rate required for each display unit.

The display signal proposed in embodiments of the present disclosure will be introduced below with reference to some examples.

Exemplarily, in embodiments of the present disclosure, the maximum image resolution that the processing unit 10 supports to process is M0*N0. The resolution may reflect the fineness of an image. Generally, a higher resolution of an image leads to more pixels contained in the image, and thus the image is clearer. The resolution may be determined by the number of pixels in a horizontal display direction and the number of pixels in a vertical display direction. The resolution M0*N0 means that the number of horizontal pixels of the image is M0, the number of vertical pixels of the image is N0, and the number of pixels of the image is a product of M0 and N0. That is, the maximum number of horizontal pixels of the image that the processing unit 10 supports to process is M0, the maximum number of vertical pixels that the processing unit 10 supports to process is N0, and the maximum number of pixels of the image that the processing unit 10 supports to process is the product of M0 and N0. For understanding of the resolution in the following, reference may be made to the description herein, and details are not described again. Optionally, the maximum resolution and/or frame rate of the image that the processing unit supports to process may be determined according to an interface capability of the processing unit 10 that is connected to an external unit.

Exemplarily, the resolution at which the first display unit 30 displays the first image is M1*N1, the resolution at which the second display unit 40 displays the second image is M2*N2, and the resolution at which the third display unit 50 displays the third image is M3*N3. In the embodiment of the present disclosure, the maximum number of pixels of an image that the processing unit 10 supports to process is greater than the number of pixels of an image displayed by each display unit, and may be expressed as M0*N0 being greater than any one of M1*N1, M2*N2, and M3*N3. Optionally, the image displayed by the display unit may be understood as an image that can be maximally supported by the display unit, and may also be understood as an image that needs to be currently displayed by the display unit.

In addition, it can be noted that the first image is a general term of an image displayed on the first display unit, and display data of the first image may be understood as display data for the first display unit, and has a correspondence with the first display unit, and does not represent a specific image. The second image and the third image are similar to the first image, and are not further described. In an actual application, the first image, the second image, and the third image may be images with different pixel content or images with the same pixel content, and pixel content included in images is not limited. Exemplarily, in an actual application, a dashboard image may be displayed on the dashboard screen, a navigation image may be displayed on an HUD panel, a game image may be displayed on a central control panel, a movie image may be displayed in a front-passenger screen, or the like.

It is assumed that the frame rate of the first display unit is greater than that of the second display unit and that of the third display unit. In order to meet the requirement of the high frame rate of the first display unit, the first part may be display data for the first display unit. Hereinafter, the display signal will be described in more detail.

The display signal includes a first type of display sub-signals and a second type of display sub-signals. Each sub-signal of the first type of display sub-signals includes a first part and a second part. The first part is display data of a first image, and the second part is display data of a second image. For ease of description, the first part and the second part of each sub-signal of the first type of display sub-signals may be considered to be spliced to form a first spliced image. Each sub-signal of the second type of display sub-signals includes a first part and a second part, the first part is display data of the first image, and the second part is display data of a third image. For ease of description, the first part and the second part of each sub-signal of the second type of display sub-signals may be considered to be spliced to form a second spliced image. In practical applications, the processing unit 10 may send the first type of display sub-signals and the second type of display sub-signals to the transmitting unit 20 in sequence, that is, send the first type of display sub-signals once, send the second type of display sub-signals once, then send the first type of display sub-signals again, and then send the second type of display sub-signals once again, etc.

Optionally, transmission frequencies of various types of display sub-signals can be designed based on a frame-rate requirement of each display unit. Exemplarily, the frame rate of the first image is 60 fps, and the frame rate of the second image and the frame rate of the third image is 30 fps. In this case, the processing unit sends, within one second, the first type of display sub-signals 30 times within one second and the second type of display sub-signals 30 times. In this way, a frame-rate requirement of each display unit can be satisfied. For another example, the frame rate of the first image is 90 fps, the frame rate of the second image is 60 fps, and the frame rate of the third image is 30 fps. In this case, the processing unit sends, within one second, the first type of display sub-signals 60 times and the second type of display sub-signals 30 times. In this way, the frame-rate requirement of each display unit can be satisfied. It can be seen that, within the unit time, the sending times of each type of display sub-signals may be the same, and may also be different.

Optionally, in order to ensure stability of signal transmission and smooth display of each display unit, and the data amount of each type of display sub-signals is the same. In other words, in the embodiment of the present disclosure, the resolution of the first spliced image may be the same as the resolution of the second spliced image. Exemplarily, the resolution of the first spliced image and the resolution of the second spliced image are M4*N4. The number of horizontal pixels of the first spliced image is less than or equal to the maximum number of horizontal pixels of the image that the processing unit 10 supports to process, and the number of vertical pixels of the first spliced image is less than or equal to the maximum number of vertical pixels of the image that the processing unit 10 supports to process. In other words, the processing unit 10 may support generation of the first spliced image as well as the second spliced image. For example, M0>M4, and N0_N4.

The number of pixels of the first spliced image is greater than or equal to a sum of the number of pixels of the first image and the number of pixels of the second image, and the number of pixels of the second spliced image is greater than or equal to a sum of the number of pixels of the first image and the number of pixels of the third image. For example, M4*N4≥(M1*N1)+(M2*N2), and M4*N4≥(M1*N1)+(M3*N3).

It can be understood that the first spliced image may include pixels of the first image and pixels of the second image, and the second spliced image may include pixels of the first image and pixels of the third image. Furthermore, the number of horizontal pixels of the image with the maximum resolution that the processing unit 10 supports to process is greater than the number of horizontal pixels of the first spliced image and the second spliced image, and the number of vertical pixels of the image with the maximum resolution that the processing unit 10 supports to process is greater than the number of vertical pixels of the first spliced image and the second spliced image.

In this method, the display signal generated by the processing unit 10 includes at least two types of display sub-signals. The first type of display sub-signals include display data for a screen with a high frame-rate requirement and display data for some screens with a low frame-rate requirement, and the second type of display sub-signals include display data for the same screen with a high frame-rate requirement and display data for other screens with a low frame-rate requirement. In this way, display sub-signals sent at one time do not need to include display data for all screens at the same time, display data for screens can be flexibly combined in the display signals, and in the case that the maximum resolution supported by the processing unit 10 is fixed, the number of screens that can be supported by the processing unit 10 can be increased.

In an example, a maximum resolution of an image that the processing unit 10 supports to process is 2560*720 and a frame rate of an image that the processing unit 10 supports to process is 60 fps. The resolution of the first image is 1280*720 and the frame rate of the first image is 60 fps; the resolution of the second image is 1280*720 and the frame rate of the second image is 30 fps; the resolution of the third image is 1280*720 and the frame rate of the third image is 30 fps. The resolution of the first spliced image may be 2560*720, where the pixels of the first image and the pixels of the second image are spliced left-right to form the first spliced image. The resolution of the second spliced image may be 2560*720, where the pixels of the first image and the pixels of the third image are spliced left-right to form the second spliced image. Reference can be made to FIG. 3, which is a schematic diagram of a first type of display sub-signals and a second type of display sub-signals provided in an embodiment of the present disclosure.

In some embodiments, in order to more flexibly combine the display data for display units, the display data for each display unit may be folded. The display data for the display unit contained in the display sub-signal may be folded display data, where the product of the fold parameter of the horizontal pixels of the display data and the fold parameter of the vertical pixels of the display data is 1. Optionally, if the fold parameter in a direction is greater than 1, the image is stretched (or referred to as extended) in the direction; if the fold parameter is less than 1 in a direction, the image is compressed in the direction; and if the fold parameter is equal to 1 in a direction, no folding operation is performed in the direction, and the original resolution remains unchanged. It can be noted that the folding operation herein changes the number of horizontal pixels and the number of vertical pixels of the image, but does not change the total number of pixels included in the image. In this way, the display data for each screen can be combined more flexibly, thereby increasing the number of screens that can be supported by the multi-screen display system.

For example, in the first spliced image, a fold parameter of horizontal pixels of the first image is 1/a, a fold parameter of vertical pixels of the first image is a, where a or 1/a is a positive integer, and exemplarily, the resolution corresponding to the display data of the folded first image is (M1/a)*(N1*a). A fold parameter of horizontal pixels of the second image is 1/b, and a fold parameter of vertical pixels of the second image is b, and exemplarily, the resolution corresponding to the display data of the folded second image is (M2/b)*(N2*b). Specifically, the number of horizontal pixels of the first spliced image is greater than or equal to a sum of the number of horizontal pixels of the folded first image and the number of horizontal pixels of the folded second image, and the number of vertical pixels of the first spliced image is greater than or equal to a sum of the number of vertical pixels of the folded first image and the number of vertical pixels of the folded second image. Exemplarily, M4≥(M1/a)+(M2/b), N4≥(N1*a)+(N2*b). When a or b is equal to 1, it indicates that an image is not folded.

In the second spliced image, a fold parameter of horizontal pixels of the first image is 1/c, and the fold parameter of vertical pixels of the first image is c, where c or 1/c is a positive integer. Exemplarily, the resolution corresponding to the display data of the folded first image is (M1/c)*(N1*c). A fold parameter of horizontal pixels of the third image is 1/d, and a fold parameter of vertical pixels of the third image is d, and exemplarily, the resolution corresponding to the display data of the folded third image is (M3/d)*(N3*d). The number of horizontal pixels of the second spliced image is greater than or equal to a sum of the number of horizontal pixels of the folded first image and the number of horizontal pixels of the folded third image. The number of vertical pixels of the second spliced image is greater than or equal to a sum of the number of vertical pixels of the folded first image and the number of vertical pixels of the folded third image. Exemplarily, M4≥(M1/c)+(M3/d), N4≥(N1*c)+(N3*d). When c or dis 1, it indicates that an image is not folded. It can be noted that values of a, b, c, and d in the foregoing examples may be the same or different. Values of a, b, c, and d are not limited in the present disclosure, which may be ½, ⅓, ¼, 2, 3, or 4.

In an example, the maximum resolution of the image that can be processed by the processing unit 10 is 2560*2160, and the frame rate is that can be processed by the processing unit 10 is 60 fps. The resolution of the first image is 2560*1080 and the frame rate of the first image is 60 fps; the resolution of the second image is 2560*1080 and the frame rate of the second image is 30 fps; and the resolution of the third image is 2560*1080, and the frame rate of the third image is 30 fps. The resolution of the first spliced image may be 2560*2160. The resolution corresponding to the display data of the first image in the first spliced image is (2560/2)*(1080*2), that is, 1280*2160. The resolution corresponding to the display data of the second image in the first spliced image is (2560/2)*(1080*2), that is, 1280*2160. The resolution of the second spliced image may be 2560*2160, and the resolution corresponding to the display data of the first image in the second spliced image is (2560/2)*(1080*2), that is, 1280*2160. The resolution corresponding to the display data of the third image in the second spliced image is (2560/2)*(1080*2), that is, 1280*2160. In this manner, folding operations are respectively performed on the first image, the second image, and the third image. Reference is made to FIG. 4, which is a schematic diagram of a first type of display sub-signals and a second type of display sub-signals provided in an embodiment of the present disclosure.

In the foregoing example, the resolutions of the first image, the second image, and the third image are the same. In some possible embodiments, resolutions of images displayed by multiple display units may also be different. In this case, the first spliced image and the second spliced image can further include padding pixels. In this way, transmission stability of display signals to be sent can be ensured. In some embodiments, if the number of pixels of the first spliced image is greater than the sum of the number of pixels of the first image and the number of pixels of the second image, exemplarily, M4*N4>(M1*N1)+(M2*N2), the display data of the first spliced image further includes padding pixels. If the number of pixels of the second spliced image is greater than the sum of the number of pixels of the first image and the number of pixels of the third image, exemplarily, M4*N4>(M1*N1)+(M3*N3), the display data of the second spliced image further includes padding pixels.

In one example, the maximum resolution of the image that can be processed by processing unit 10 is 3840*2160 and the frame rate of the image that can be processed by processing unit 10 is 60 fps. The resolution of the first image is 2560*1080 and the frame rate of the first image is 60 fps; the resolution of the second image is 1920*1080 and the frame rate of the second image is 30 fps; and the resolution of the third image is 1280*720 and the frame rate of the third image is 30 fps. The resolution of the first spliced image may be 3840*2160. The resolution corresponding to the display data of the first image in the first spliced image is 2560*1080; the resolution corresponding to the display data of the second image in the first spliced image is (1920/2)*(1080*2), that is, 960*2160. In addition to the display data of the first image and the display data of the second image, the first spliced image further includes padding pixels. The resolution of the second spliced image may be 3840*2160. The resolution corresponding to the display data of the first image in the second spliced image is 2560*1080; and the resolution corresponding to the display data of the third image in the second spliced image is (1280/2)*(720*2), that is, 640*1440. In addition to the display data of the first image and display data of the third image, the second spliced image further includes padding pixels. In this manner, a folding operation is performed on each of the second image and the third image.

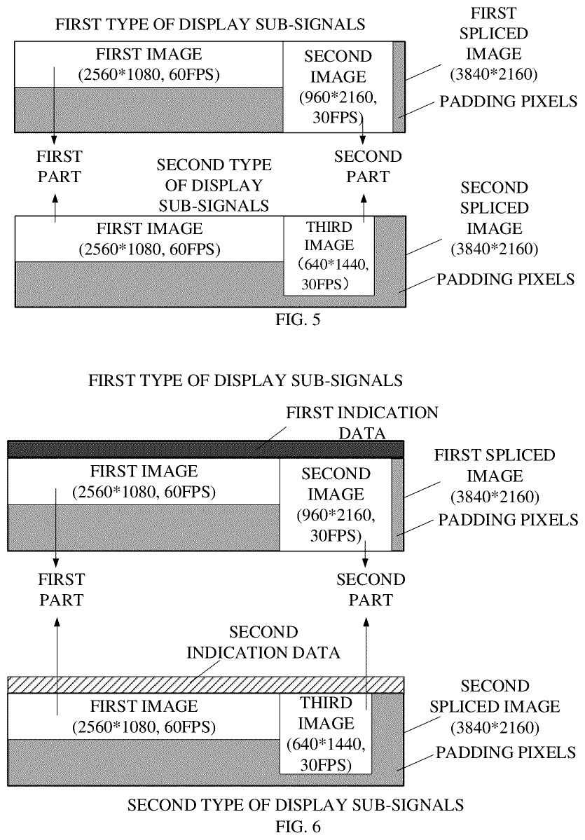

In an actual application, it may be defined that the first spliced image includes background data of a size of 3840*2160, and then display data of the first image and display data of the second image are placed in the background data. Likewise, the second spliced image may also be processed similarly. Reference is made to FIG. 5, which is a schematic diagram of a first type of display sub-signals and a second type of display sub-signals provided in an embodiment of the present disclosure.

It can be noted that the resolution of the first spliced image or the second spliced image may not be the same as the maximum resolution of the image that the processing unit 10 supports to process. The number of horizontal pixels of the first spliced image is greater than or equal to the sum of the numbers of horizontal pixels of the first image and the second image, and the number of vertical pixels of the first spliced image is greater than or equal to the sum of the numbers of vertical pixels of the first image and the second image. The number of horizontal pixels of the second spliced image is greater than or equal to the sum of the numbers of horizontal pixels of the first image and the third image, and the number of vertical pixels of the second spliced image is greater than or equal to the sum of the numbers of vertical pixels of the first image and the third image. Exemplarily, in the example illustrated in FIG. 5, the resolution of the first spliced image may be 3520*2160, and the resolution of the second spliced image may be 3520*2160. To ensure stability of signal transmission, resolutions of the first spliced image and the second spliced image may be the same.

In some embodiments, in order to distinguish different types of display sub-signals, indication data may be added to the display sub-signal, in other words, the display sub-signal contains indication data, and the indication data indicates a display unit corresponding to display data contained in the display sub-signal.

Exemplarily, the indication data may be flag data in a frame. Optionally, the first type of display sub-signals contains first indication data, and the first indication data indicates that display data contained in the first type of display sub-signals corresponds to the first display unit and the second display unit. In other words, the display data of the first spliced image includes the display data of the first image and the display data of the second image. The second type of display sub-signals contains second indication data, and the second indication data indicates that the display data contained in the second type of display sub-signals corresponds to the first display unit and the third display unit. In other words, the display data of the second spliced image includes the display data of the first image and the display data of the third image.

In some possible embodiments, the indication data may be located at a head, a partial head, or a tail of the display sub-signal. The first indication data of the first type of display sub-signals is different from the second indication data of the second type of display sub-signals. For example, the first type of display sub-signals and the second type of display sub-signals respectively include the first spliced image and the second spliced image in the embodiment corresponding to FIG. 5. Reference is made to FIG. 6, which is a schematic diagram of a first type of display sub-signals and a second type of display sub-signals provided in an embodiment of the present disclosure.

In the foregoing example, for illustrative purpose, the multiple display units include three display units is introduced. In embodiments of the present disclosure, the multiple display units can further include more display units.

In some embodiments, the multiple display units further include some display units with high frame-rate requirements similar to that of the first display unit 30. Optionally, the multiple display units further include a fourth display unit, where a resolution of the fourth display unit for displaying a fourth image is M5*N5, a frame rate of the fourth display unit for displaying the fourth image is Q4, and the frame rate of the fourth display unit for displaying the fourth image is greater than or equal to the frame rate of the first display unit for displaying the first image, that is, Q4≥Q1. That is, the frame-rate requirement of the fourth display unit is higher than or equal to the frame-rate requirement of the first display unit 30. If the frame-rate requirement of the fourth display unit is the same as the frame-rate requirement of the first display unit, the first part of each type of display sub-signals also needs to contain the display data of the fourth image, that is, the display data for the first display unit and the display data of the fourth display unit jointly form the first part. If the frame-rate requirement of the fourth display unit is higher than that of the first display unit, the display data of the fourth display unit may be used as the new first part.

In addition, the transmitting unit 20 is further configured to send the display data for the fourth image to the fourth display unit.

In one example, the frame rate of the first image is 60 fps, the frame rate of the second image is 30 fps, the frame rate of the third image is 30 fps, and the frame rate of the fourth image is 60 fps. In this case, the multiple types of display sub-signal include a first type of display sub-signals and a second type of display sub-signals. First parts of the first type of display sub-signals are display data of the first image and the fourth image, and second parts of the first type of display sub-signals are display data of the second image. First parts of the second type of display sub-signals are display data of the first image and the fourth image, and second parts of the second type of display sub-signals are display data of the third image. In another example, the frame rate of the first image is 60 fps, the frame rate of the second image is 30 fps, the frame rate of the third image is 30 fps, and the frame rate of the fourth image is 90 fps. In this case, the multiple types of display sub-signals include a first type of display sub-signals, a second type of display sub-signals, and a third type of display sub-signals. First parts of the first type of display sub-signals are display data of the fourth image, and second parts of the first type of display sub-signals are display data of the first image and the second image. First parts of the second type of display sub-signals are the display data of the fourth image, and second parts of the second type of display sub-signals are the display data of the first image and the third image. First parts of the third type of display sub-signals are display data of the fourth image, and second parts of the third type of display sub-signals are padding pixels, that is, the second parts correspond to no display units, and second parts of the third type of display sub-signals which are blanking are different from second parts of the other display sub-signals.

In some embodiments, the number of pixels of the first spliced image is greater than or equal to a sum of the number of pixels of the first image, the number of pixels of the second image, and the number of pixels of the fourth image, and the number of pixels of the second spliced image is greater than or equal to a sum of the number of pixels of the first image, the number of pixels of the third image, and the number of pixels of the fourth image. For example, M4*N4≥(M1*N1)+(M2*N2)+(M5*N5), and M4*N4≥(M1*N1)+(M3*N3)+(M5*N5).

It can be noted that, the multiple display units may also include more display units with a high frame-rate requirement similar to that of the first display unit 30, and in this case, similar processing may be performed, and the number of the display units having a high frame rate is not limited in this embodiment.

In an example, the maximum resolution of an image that processing unit 10 supports to process is 3840*2160 and the frame rate of an image that processing unit 10 supports to process is 60 fps. The first image has a resolution of 2560*1080 and a frame rate of 60 fps; the second image has a resolution of 2560*1080 and a frame rate of 30 fps; the third image has a resolution of 2560*1080 and a frame rate of 30 fps; and the fourth image has a resolution of 2560*1080 and a frame rate of 60 fps. The resolution of the first spliced image may be 3840*2160. The resolution corresponding to the display data of the first image in the first spliced image is (2560/2)*(1080*2), that is, 1280*2160; the resolution corresponding to the display data of the second image in the first spliced image is (2560/2)*(1080*2), that is, 1280*2160; and the resolution corresponding to the display data of the fourth image in the first spliced image is (2560/2)*(1080*2), that is, 1280*2160. The resolution of the second spliced image may be 3840*2160. The resolution corresponding to the display data of the first image in the second spliced image is (2560/2)*(1080*2), that is, 1280*2160; the resolution corresponding to the display data of the third image in the second spliced image is (2560/2)*(1080*2), that is, 1280*2160; and the resolution corresponding to the display data of the fourth image in the second spliced image is (2560/2)*(1080*2), that is, 1280*2160. In this manner, the folding operation is performed on each of the first image, the second image, the third image, and the fourth image.

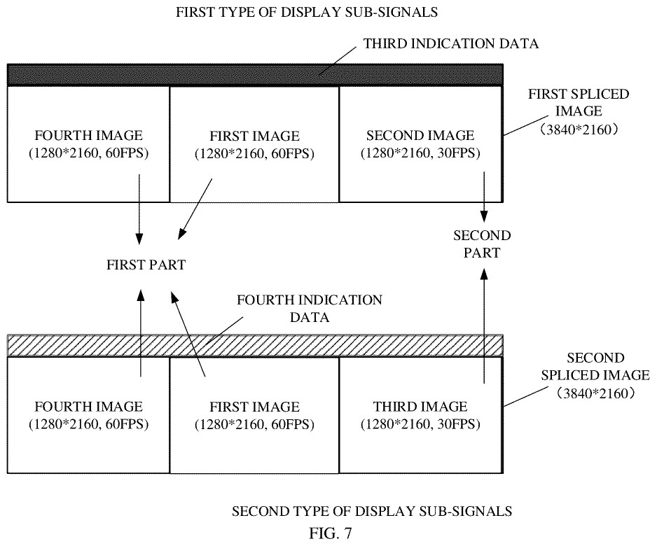

Reference is made to FIG. 7, which is a schematic diagram of a first type of display sub-signals and a second type of display sub-signals provided in an embodiment of the present disclosure. Optionally, the first type of display sub-signals can further include third indication data, where the third indication data indicates that display units corresponding to the first type of display sub-signals are the first display unit, the second display unit, and the fourth display unit. The second type of display sub-signals include fourth indication data, where the fourth indication data indicates that display units corresponding to the second type of display sub-signals are the first display unit, the third display unit, and the fourth display unit.

In yet another example, the maximum resolution of an image that processing unit 10 supports to process is 3840*2160 and the frame rate of an image that processing unit 10 supports to process is 60 fps. The first image has a resolution of 2560*1080 and a frame rate of 60 fps; the second image has a resolution of 1920*1080 and a frame rate of 30 fps; the third image has a resolution of 1280*720 and a frame rate of 30 fps; and the fourth image has a resolution of 1280*720 and a frame rate of 60 fps. The resolution of the first spliced image may be 3840*2160. The resolution corresponding to the display data of the first image in the first spliced image is 2560*1080; the resolution corresponding to the display data of the second image in the first spliced image is (1920/2)*(1080*2), that is, 960*2160; and the resolution corresponding to the display data of the fourth image in the first spliced image is 1280*720. In the first spliced image, in addition to display data of the first image, display data of the second image, and display data of the fourth image, the first spliced image includes padding pixels. The resolution of the second spliced image may be 3840*2160, and the resolution corresponding to the display data of the first image in the second spliced image is 2560*1080; the resolution corresponding to the display data of the third image in the second spliced image is (1280/2)*(720*2), that is, 640*1440; and the resolution corresponding to the display data of the fourth image in the second spliced image is 1280*720. In the second spliced image, in addition to display data of the first image, display data of the third image and display data of the fourth image, the second spliced image includes padding pixels. In this manner, a folding operation is performed on each of the second image and the third image. In an actual application, it may be defined that the first spliced image includes background data of a size of 3840*2160, and then display data of the first image, display data of the second image, and display data of the fourth image are placed on the background data. Likewise, the second spliced image may also be processed similarly.

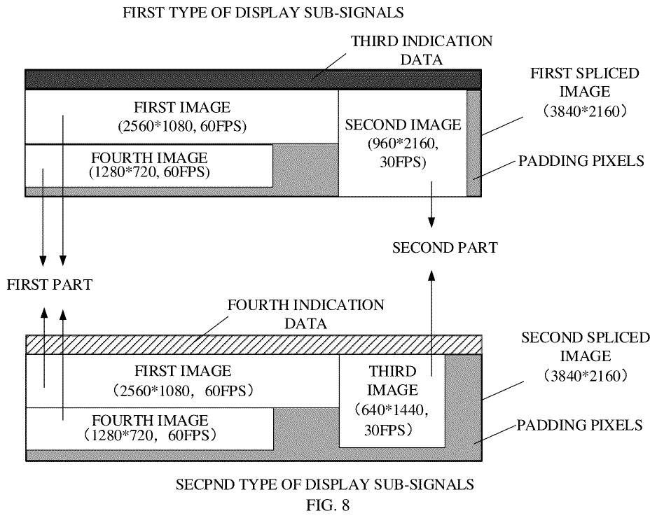

Exemplarily, reference is made to FIG. 8, that is a schematic diagram of a first type of display sub-signals and a second type of display sub-signals provided in an embodiment of the present disclosure. Optionally, the first type of display sub-signals can further include third indication data, where the third indication data indicates that display units corresponding to the first type of display sub-signals are the first display unit, the second display unit, and the fourth display unit. The second type of display sub-signals include fourth indication data, where the fourth indication data indicates that display units corresponding to the second type of display sub-signals are the first display unit, the third display unit, and the fourth display unit.

Optionally, in this example, there exist another possible folding manner of the image. Exemplarily, the folding operation may also be performed on each of the first image, the second image, the third image, and the fourth image. In some possible embodiments, the resolution of the first spliced image may be 3840*2160. The resolution corresponding to display data of the first image in the first spliced image is (2560/2)*(1080*2), that is, 1280*2169; the resolution corresponding to the display data of the second image in the first spliced image is (1920/2)*(1080*2), that is, 960*2160; the resolution corresponding to the display data of the fourth image in the first spliced image is (1280/2)*(720*2), that is, 640*1440. In the first spliced image, in addition to display data of the first image, display data of the second image, and display data of the fourth image, the first spliced image includes padding pixels. The resolution of the second spliced image may be 3840*2160. The resolution corresponding to the display data of the first image in the second spliced image is (2560/2)*(1080*2), that is, 1280*2169; the resolution corresponding to the display data of the third image in the second spliced image is (1280/2)*(720*2), that is, 640*1440; and the resolution corresponding to the display data of the fourth image in the second spliced image is (1280/2)*(720*2), that is, 640*1440. In the second spliced image, in addition to display data of the first image, display data of the third image, and display data of the fourth image, the second spliced image includes padding pixels.

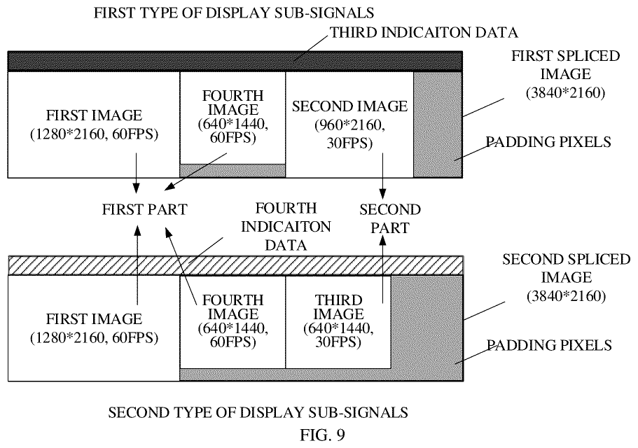

Exemplarily, reference is made to FIG. 9, which is a schematic diagram of a first type of display sub-signals and a second type of display sub-signals provided in an embodiment of the present disclosure. Optionally, the first type of display sub-signals can further include third indication data, where the third indication data indicates that display units corresponding to the first type of display sub-signals are the first display unit, the second display unit, and the fourth display unit. The second type of display sub-signals include fourth indication data, where the fourth indication data indicates that display units corresponding to the second type of display sub-signals are the first display unit, the third display unit, and the fourth display unit.

In some embodiments, the multiple display units further include some display units with low frame-rate requirements similar to those of the second display unit 40 and the third display unit 50.

In a possible embodiment, the display signal can further include other types of display sub-signals.

Exemplarily, the multiple display units further include a fifth display unit and a sixth display unit, where the fifth display unit displays a fifth image at a resolution of M6*N6, and the sixth display unit displays a sixth image at a resolution of M7*N7. The frame rates of the fifth display unit and the sixth display unit are relatively small and less than the frame rate of the first display unit.

If the frame rate of the first display unit is four times of each of the frame rate of the second display unit, the frame rate of the third display unit, the frame rate of the fifth display unit, and the frame rate of the sixth display unit. In this case, in addition to the first type of display sub-signals and the second type of display sub-signals, the display signal can further include a third type of display sub-signals and a fourth type of display sub-signals. Each sub-signal of the third type of display sub-signals includes a first part and a second part, where the first part is display data of a first image, and the second part is display data of a fifth image. For ease of description, it can be considered that the first part and the second part of each sub-signal of the third type of display sub-signals are spliced to form a third spliced image. Each sub-signal of the fourth type of display sub-signals includes a first part and a second part, where the first part is display data of the first image, and the second part is display data of the sixth image. For ease of description, it can be considered that the first part and the second part of each sub-signal of the fourth type of display sub-signals may be considered are spliced to form a fourth spliced image. The transmitting unit 20 is further configured to send the display data of the fifth image to the fifth display unit and send the display data of the sixth image to the sixth display unit.

The resolution of the third spliced image, the resolution of the fourth spliced image, the resolution of the first spliced image, and the resolution of the second spliced image are all the same. Exemplarily, the resolutions of the third spliced image and the fourth spliced image are M4*N4.

The number of pixels of the third spliced image is greater than or equal to a sum of the number of pixels of the first image and the number of pixels of the fifth image, and the number of pixels of the fourth spliced image is greater than or equal to a sum of the number of pixels of the first image and the number of pixels of the sixth image. For example, M4*N4≥(M1*N1)+(M6*N6), and M4*N4≥(M1*N1)+(M7*N7).

In an example, the maximum resolution of an image that processing unit 10 supports to process is 2560*2160 and the frame rate of an image that processing unit 10 supports to process is 120 fps. The first image has a resolution of 2560*1080 and a frame rate of 120 fps; the second image has a resolution of 2560*1080 and a frame rate of 30 fps; the third image has a resolution of 2560*1080 and a frame rate of 30 fps; the fifth image has a resolution of 2560*1080 and a frame rate of 30 fps; and the sixth image has a resolution of 2560*1080 and a frame rate of 30 fps. The resolution of the first spliced image may be 2560*2160. In this case, the resolution corresponding to the display data of the first image in the first spliced image is (2560/2)*(1080*2), that is, 1280*2160; and the resolution corresponding to the display data of the second image in the first spliced image is (2560/2)*(1080*2), that is, 1280*2160. The resolution of the second spliced image may be 2560*2160. In this case, the resolution corresponding to the display data of the first image in the first spliced image is (2560/2)*(1080*2), that is, 1280*2160; and the resolution corresponding to the display data of the third image in the first spliced image is (2560/2)*(1080*2), that is, 1280*2160. The resolution of the third spliced image may be 2560*2160. In this case, the resolution corresponding to the display data of the first image in the third spliced image is (2560/2)*(1080*2), that is, 1280*2160; and the resolution corresponding to the display data of the fifth image in the third spliced image is (2560/2)*(1080*2), that is, 1280*2160. The resolution of the fourth spliced image may be 2560*2160. In this case, the resolution corresponding to the display data of the first image in the fourth spliced image is (2560/2)*(1080*2), that is, 1280*2160; and the resolution corresponding to the display data of the sixth image in the fourth spliced image is (2560/2)*(1080*2), that is, 1280*2160. In this manner, the folding operation is performed on each of the first image, the second image, the third image, the fifth image, and the sixth image.

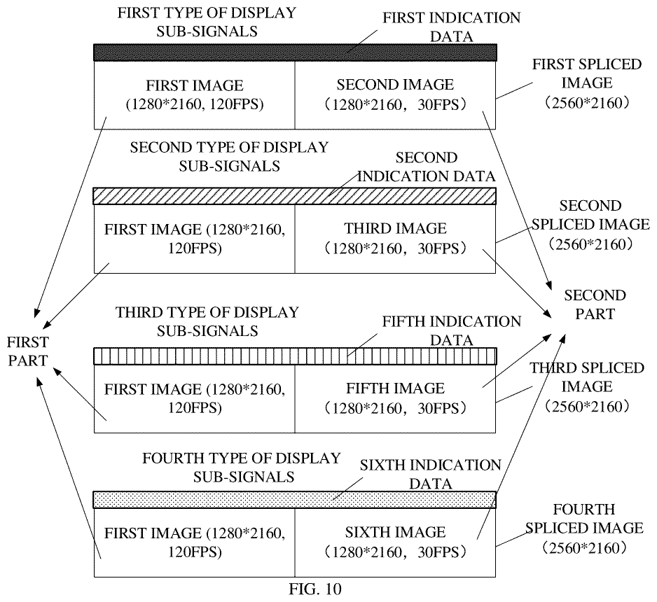

FIG. 10 is a schematic diagram of a first type of display sub-signals, a second type of display sub-signals, a third type of display sub-signals, and a fourth type of display sub-signals provided in an embodiment of the present disclosure. Optionally, the first type of display sub-signals contains first indication data, and the first indication data indicates that display data contained in the first type of display sub-signals corresponds to the first display unit and the second display unit. The second type of display sub-signals contains second indication data, and the second indication data indicates that the display data contained in the second type of display sub-signals corresponds to the first display unit and the third display unit. The third type of display sub-signals can further include fifth indication data, where the fifth indication data indicates that display data contained in the third type of display sub-signals corresponds to the first display unit and the fifth display unit. The fourth type of display sub-signals contains sixth indication data, and the sixth indication data indicates that display data contained in the fourth type of display sub-signals corresponds to the first display unit and the sixth display unit.

Optionally, in another possible embodiment, if supported by the image-processing capability of the processing unit, display data of a displayed image of a display unit with a low frame-rate requirement may also be added to the second part of the display sub-signal.

Exemplarily, the multiple display units further include a seventh display unit and an eighth display unit, where a frame rate of the first display unit is greater than an integral multiple of each of a frame rate of the seventh display unit for displaying the seventh image and a frame rate of the eighth display unit for displaying the eighth image. If the frame rates of the seventh display unit and the eighth display unit are the same as the frame rates of the second display unit and the third display unit, the second part of the first type of display sub-signals can further include display data of the seventh image, and the second part of the second type of display sub-signals can further include display data of the eighth image. Furthermore, the transmitting unit 20 is further configured to transmit the display data of the seventh image to the seventh display unit, and transmit the display data of the eighth image to the eighth display unit.

In an embodiment, the number of pixels of the first spliced image is greater than or equal to the sum of the number of pixels of the first image, the number of pixels of the second image, and the number of pixels of the seventh image. The number of pixels of the second spliced image is greater than or equal to the sum of the number of pixels of the first image, the number of pixels of the third image, and the number of pixels of the eighth image. Optionally, the number of horizontal pixels of the first spliced image is greater than or equal to the sum of the number of horizontal pixels of the folded first image, the number of horizontal pixels of the folded second image, and the number of horizontal pixels of the folded seventh image. The number of vertical pixels of the first spliced image is greater than or equal to the sum of the number of vertical pixels of the folded first image, the number of vertical pixels of the folded second image, and the number of vertical pixels of the folded seventh image. The number of horizontal pixels of the second spliced image is greater than or equal to the sum of the number of horizontal pixels of the folded first image, the number of horizontal pixels of the folded third image, and the number of horizontal pixels of the folded eighth image. The number of vertical pixels of the second spliced image is greater than or equal to the sum of the number of vertical pixels of the folded first image, the number of vertical pixels of the folded third image, and the number of vertical pixels of the folded eighth image. It can be noted that, some images may not be subject to the folding operation, so that the fold parameter may be considered as 1.

In an example, the maximum resolution of an image that processing unit 10 supports to process is 3840*2160 and the frame rate of an image that processing unit 10 supports to process is 60 fps. The first image has a resolution of 2560*1080 and a frame rate of 60 fps; the second image has a resolution of 1920*1080 and a frame rate of 30 fps; the third image has a resolution of 1280*720 and a frame rate of 30 fps; the seventh image has a resolution of 1280*720 and a frame rate of 30 fps; and the eighth image has a resolution of 1280*720 and a frame rate of 30 fps. In some possible embodiments, the resolution of the first spliced image may be 2880*2160. In this case, the resolution corresponding to display data of the first image in the first spliced image is (2560/2)*(1080*2), that is, 1280*2169; the resolution corresponding to the display data of the second image in the first spliced image is (1920/2)*(1080*2), that is, 960*2160; the resolution corresponding to the display data of the seventh image in the first spliced image is (1280/2)*(720*2), that is, 640*1440. In addition to the display data of the first image, the display data of the second image, and the display data of the seventh image, the first spliced image includes padding pixels. The resolution of the second spliced image may be 2880*2160. In this case, the resolution corresponding to the display data of the first image in the second spliced image is (2560/2)*(1080*2), that is, 1280*2169; the resolution corresponding to the display data of the third image in the second spliced image is (1280/2)*(720*2), that is, 640*1440; the resolution corresponding to the display data of the eighth image in the second spliced image is (1280/2)*(720*2), that is, 640*1440. In the second spliced image, in addition to the display data of the first image, the display data of the third image, and the display data of the eighth image, the second spliced image includes padding pixels.

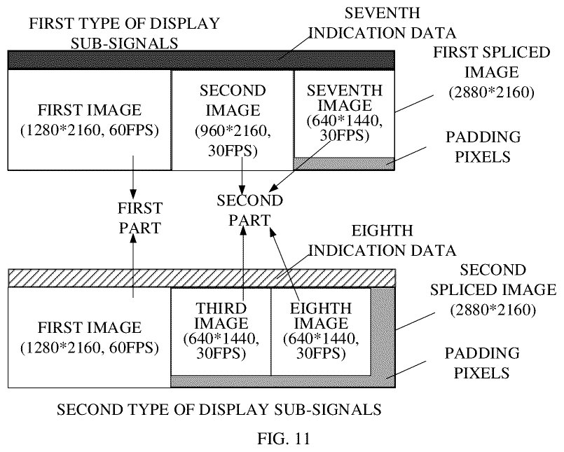

Exemplarily, reference is made to FIG. 11, that is a schematic diagram of a first type of display sub-signals and a second type of display sub-signals provided in an embodiment of the present disclosure. Optionally, the first type of display sub-signals can further include seventh indication data, where the seventh indication data indicates that the display data contained in the first type of display sub-signals corresponds to the first display unit, the second display unit, and the seventh display unit. The second type of display sub-signals contains eighth indication data, where the eighth indication data indicates that display data contained in the second type of display sub-signals corresponds to the first display unit, the second display unit, and the eighth display unit.

It can be noted that, the multiple display units can further include more display units with a low frame-rate requirement similar to those of the second display unit 40 and the third display unit 50. In this case, similar processing may be performed. In this embodiment, the number of display units with low frame rates is not limited. In some possible embodiments, the multiple display units may include not only more display units with high frame-rate requirements but also more display units with low frame-rate requirements, and the display signals may be designed in the manner described above. The number of display units display-frame-rate requirements of display units are not limited in embodiments of the present disclosure. According to a display-signal design method in the above description, when the number of display units with high frame-rate requirements and/or low frame-rate requirements is increased, the multi-screen display system can also support more display units. In addition, the multiple display units are not always turned on at the same time, and the method provided in embodiments of the present disclosure is also applicable to an application scenario where some display units are turned on and some display units are turned off.

Various possible situations of display signals generated by the processing unit 10 have been described above, and the transmitting unit 20 will be further described below.

In the present disclosure, the transmitting unit 20 may receive a display signal sent by the processing unit 10, parse content in the display signal, and then send parsed display data to a display unit(s) corresponding to the display data. In some embodiments, the transmitting unit 20 is configured to receive a display signal sent by the processing unit 10, send display data of the first image to the first display unit 30, send display data of the second image to the second display unit 40, and send display data of the third image to the third display unit 50.

In a possible embodiment, if the display sub-signal contains the first indication data, then the transmitting unit 20 can determine, based on the first indication data, that the data contained in the currently received display sub-signal corresponds to the first display unit 30 and the second display unit 40, Then, the transmitting unit 20 sends the display data of the first image to the first display unit 30, and sends the display data of the second image to the second display unit 40. If the display sub-signal contains the second indication data, the transmitting unit 20 may determine, based on the second indication data, that the data contained in the currently received display sub-signal corresponds to the first display unit 30 and the third display unit 50, and then the transmitting unit 20 sends the display data of the first image to the first display unit 30 and sends the display data of the third image to the third display unit 50.

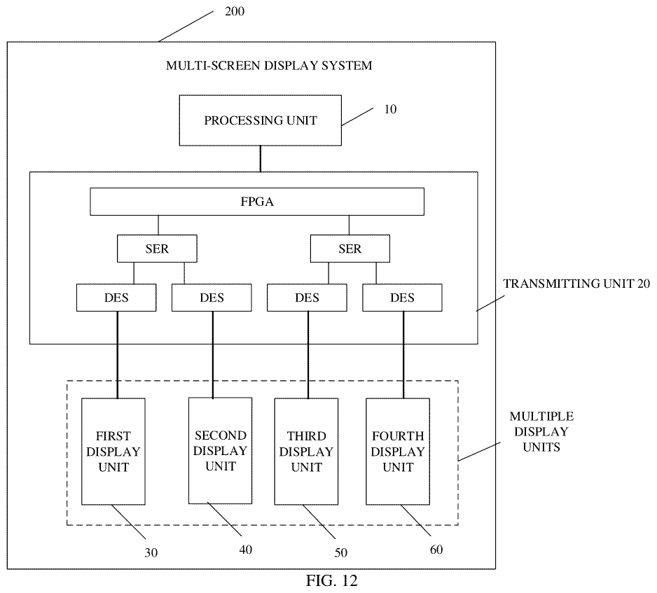

In some possible embodiments, the transmitting unit 20 may extend the display interface by reusing technologies such as the FPGA technology and the FPD-LINK. Reference is made to FIG. 12, which is a schematic diagram of another multi-screen display system 200 provided in an embodiment of the present disclosure. The multi-screen display system 200 includes a processing unit 10, a transmitting unit 20, and multiple display units. The multiple display units include a first display unit 30, a second display unit 40, a third display unit 50, and a fourth display unit 60.

The transmitting unit 20 includes one FPGA module, two serializers (SER)/modules, and four deserializers (DES) modules, and each of the four DES modules is connected to one display unit. The FPGA module is configured to parse a received display signal, and determine which display units correspond to the display data contained in the display signals. The SER module is configured to convert display data from the FPGA module into a required format, exemplarily, convert display data of a display serial interface (DSI) format into an FPD-LINK format; and send the display data subject to format conversion to the DES module. The DES module is configured to parse the display data sent by the SER module, and send the display data to a corresponding display unit.

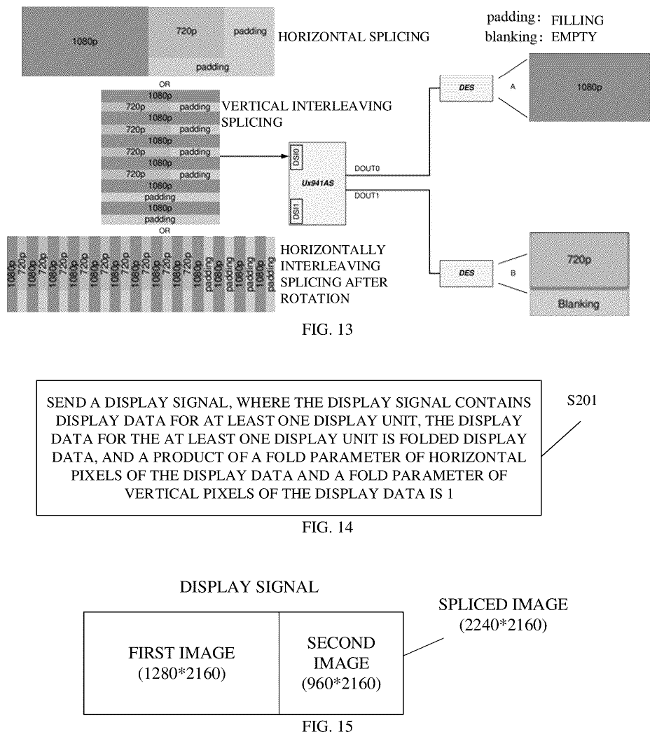

The FPGA module can splice display data of display units according to the requirement of the SER module. Optionally, a manner of splicing display data is pre-stored in the FPGA module. Reference is made to FIG. 13, which is a schematic diagram of output display data provided in an embodiment of the present disclosure. In FIG. 13, the display data output by the FPGA module includes display data for a screen A and display data for a screen B. The screen A displays an image of 1080P (corresponding to 1920*1080 pixels), and the screen B displays an image of 720P (corresponding to 1280*720 pixels).

There are three optional display data design manners, which are respectively introduced below.
1. Horizontal splicing. Content for the screen B is padded into data of 1080p, and display data for the screen A and display data for the screen B are spliced to form display data of 3840*1080 to be sent to the SER module, where the SER module is schematically a U×941AS plus a serial chip in FIG. 11.
2. Vertical interleaving splicing. Content for the screen B are padded into display data of 1920*720, and display data for the screen A and display data for the screen B are spliced into data of 1920*1800 to be sent to the SER module.
3. Horizontally interleaving splicing after rotation. Content for the screen B are padded into data of 1920*720, and display data for the screen A and display data for the screen B are spliced into data of 1920*1800, the data of 1920*1800 is rotated into data of 1800*1920 to be sent to the SER module.

In some embodiments of the present disclosure, the display data for various screens can be sent by folding the display data to be sent. Reference is made to FIG. 14, which is a flowchart of yet another transmission method for display data provided in an embodiment of the present disclosure. The method may be applied to the multi-screen display system illustrated in FIG. 1, and an execution body of the method may be the processing unit in FIG. 1. It can be noted that, the method does not limit the number of display units included in the multi-screen display system, and the method includes the following operations.

S201, a display signal is sent.

Optionally, the processing unit 10 generates and sends a display signal to the transmitting unit 20, where the display signal contains display data for at least one display unit, the display data for the at least one display unit is the display data subjected to the folding processing, and the product of the fold parameter of the horizontal pixels of the display data and the fold parameter of the vertical pixels of the display data is 1.

Optionally, if the fold parameter in a direction is greater than 1, the image is stretched (or referred to as extended) in the direction; if the fold parameter is less than 1 in a direction, the image is compressed in the direction; and if the fold parameter is equal to 1 in a direction, no folding operation is performed in the direction, and the original resolution remains unchanged. It can be noted that the folding operation herein changes the number of horizontal pixels and the number of vertical pixels of the image, but does not change the total number of pixels included in the image. In this way, the display data for each screen can be combined more flexibly, thereby increasing the number of screens that can be supported by the multi-screen display system.

In some examples, the first display unit is configured to display a first image, and the second display unit is configured to display a second image. Exemplarily, a maximum resolution of an image that the processing unit 10 supports to process is M0*N0, a resolution of the first display unit 30 for displaying the first image is M1*N1, and a resolution of the second display unit 40 for displaying the second image is M2*N2. In embodiments of the present disclosure, the maximum number of pixels of the image that the processing unit 10 supports to process is greater than the number of pixels of the image displayed by each display unit, for example, M0*N0>M1*N1, and M0*N0>M2*N2. The frame rates of images displayed by the first display unit 30 and the second display unit 40 are not limited, and the frame rates of images displayed by the first display unit 30 and the second display unit 40 may be the same. In addition, the maximum frame rate supported by the processing unit 10 is greater than or equal to the frame rate displayed by each display unit. Display data of the first image may be understood as display data for the first display unit 30, and display data of the second image may be understood as display data of the second display unit 40.

The display signal contains display data of at least one display unit, for example, display data for a first display unit. Exemplarily, the fold parameter of the horizontal pixels of the first image is 1/a, and the fold parameter of the vertical pixels of the first image is a, where a or 1/a is positive integer. The resolution corresponding to the display data of the folded first image is (M1/a)*(N1*a). The maximum number of horizontal pixels of an image that the processing unit 10 supports to process is greater than M1/a, and the maximum number of vertical pixels of an image that the processing unit 10 supports to process is greater than N1*a.

In another example, the display signal contains display data for a first display unit and display data for a second display unit. For the sake of description, the display data for the first display unit and the display data for the second display unit are spliced to form a spliced image. The number of pixels of the spliced image is greater than or equal to the sum of the number of pixels of the first image and the number of pixels of the second image, the number of horizontal pixels of the spliced image is less than or equal to the maximum number of horizontal pixels of an image that the processing unit supports to process, and the number of vertical pixels of the spliced image is less than or equal to the maximum number of vertical pixels of an image that the processing unit supports to process. Exemplarily, the spliced image has a resolution of M4*N4, M4*N4≥(M1*N1)+(M2*N2), M0≥M4, N0≥N4. It may be understood that the spliced image may include pixels of the first image and the second image at the same time. Furthermore, the number of horizontal pixels of the image with the maximum resolution that the processing unit 10 supports to process is greater than the number of horizontal pixels of the spliced image, and the number of vertical pixels of the image with the maximum resolution that the processing unit 10 supports to process is greater than the number of vertical pixels of the spliced image.

In the spliced image, a fold parameter of horizontal pixels of the first image is 1/a, and a fold parameter of vertical pixels of the first image is a, where a or 1/a is a positive integer. Exemplarily, the resolution corresponding to display data of the folded first image is (M1/a)*(N1*a). A fold parameter of horizontal pixels of the second image is 1/b, and a fold parameter of vertical pixels of the second image is b, where b or 1/b is a positive integer. Exemplarily, the resolution corresponding to display data of the folded second image is (M2/b)*(N2*b). The number of horizontal pixels of the spliced image is greater than or equal to a sum of the number of horizontal pixels of the folded first image and the number of horizontal pixels of the folded second image, and the number of vertical pixels of the spliced image is greater than or equal to a sum of the number of vertical pixels of the folded first image and the number of vertical pixels of the folded second image. Exemplarily, M4≥(M1/a)+(M2/b) , and N4≥(N1/a)+(N2/b) . When a or b is equal to 1, it indicates that an image is not folded. It can be noted that values of a and b in the foregoing examples may be the same or different. A value of a fold parameter is limited in the present disclosure, which may be, for example, ½, ⅓, ¼, 2, 3, or 4.

In an example, the maximum resolution of an image that processing unit 10 supports to process is 2560*2160. The resolution of the first image is 2560*1080, and the resolution of the second image is 960*2160. If the existing transmission method is used, due to the effect of the resolution, the processing unit 10 is unable to support the transmission of the first image and the transmission of the second image at the same time. In embodiments of the present disclosure, the folding operation may be performed on the first image, and in the spliced image, the resolution corresponding to the display data of the first image may be (2560/2)*(1080*2), that is, 1280*2160. In the spliced image, the resolution corresponding to the display data of the second image may be 960*2160.

In an actual application, it may be defined that a spliced image includes background data of a size of 2560*2160, and then display data of the first image and display data of the second image are placed on the background data. It can be noted that the resolution of the spliced image may not be the same as the maximum resolution of the image that the processing unit 10 supports to process. Exemplarily, the resolution of the spliced image may be 2240*2160. Reference is made to FIG. 15, which is a schematic diagram of a display signal provided in an embodiment of the present disclosure.

In an embodiment, if the number of pixels of the spliced image is greater than a sum of the number of pixels of the first image and the number of pixels of the second image, the display data of the spliced image further includes padding pixels.

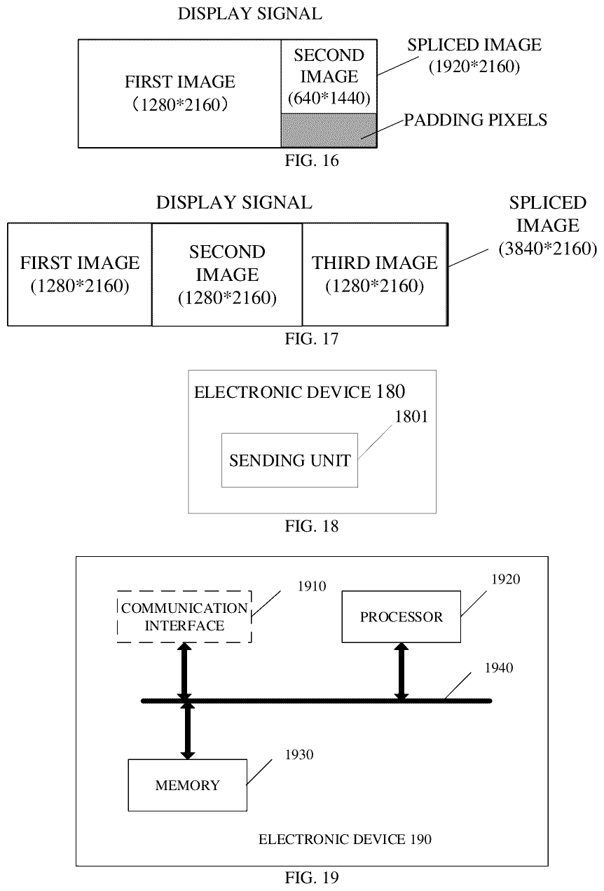

In another example, the maximum resolution of the images that processing unit 10 supports to process is 2560*2160. A resolution of the first image is 2560*1080, and a resolution of the second image is 640*1440. In the spliced image, a resolution corresponding to display data of the first image may be (2560/2)*(1080*2), that is, 1280*2160; and the resolution corresponding to the display data of the second image may be 640*1440. The resolution of the spliced image may be 1920*2160. Optionally, in addition to display data of the first image and display data of the second image, the spliced image may include padding pixels. FIG. 16 is a schematic diagram of another display signal provided in an embodiment of the present disclosure.

In this embodiment, the transmitting unit 20 may receive the display signal sent by the processing unit 10, then parse the content in the display signal, and then send the parsed display data to the display unit corresponding to the display data. In some embodiments, the transmitting unit 20 transmits the display data of the first image to the first display unit 30, and transmits the display data of the second image to the second display unit 40.

Optionally, the multiple display units can further include more display units. Exemplarily, the multiple display units further include a third display unit. Exemplarily, a resolution of the third display unit for displaying the third image is M3*N3. In this case, the display data of the spliced image further includes the display data of the third image.

The number of pixels of the spliced image is greater than or equal to a sum of the number of pixels of the first image, the number of pixels of the second image, and the number of pixels of the third image. Exemplarily, M4*N4>(M1*N1)+(M2*N2)+(M3*N3) . Specifically, in the spliced image, a fold parameter of horizontal pixels of the third image is 1/c, and a fold parameter of vertical pixels of the third image is c, where c or 1/c is a positive integer. Exemplarily, the resolution corresponding to the display data of the folded third image is (M3/c)*(N3*c). The number of horizontal pixels of the spliced image is greater than or equal to the sum of the number of horizontal pixels of the folded first image, the number of horizontal pixels of the folded second image, and the number of horizontal pixels of the folded third image. The number of vertical pixels of the spliced image is greater than or equal to a sum of the number of vertical pixels of the folded first image, the number of vertical pixels of the folded second image, and the number of vertical pixels of the folded third image. Exemplarily, M4>(M1/a)+(M2/b)+(M3/c) , and N4>(N1*a)+(N2*b)+(N3*c). In other words, the number of horizontal pixels of the spliced image is greater than or equal to the sum of the numbers of horizontal pixels of the first image, the second image, and the third image, and the number of vertical pixels of the first spliced image is greater than or equal to the sum of the numbers of vertical pixels of the first image, the second image, and the third image. The transmitting unit 21 is further configured to send display data of the third image to the third display unit.

It can be noted that, the multiple display units can further include more display units, which can be processed similarly in this case, and the number of display units is not limited in embodiments of the present disclosure.

In an example, the maximum resolution of the image that processing unit 10 supports to process is 3840*2160. The resolution of the first image is 2560*1080, the resolution of the second image is 2560*1080, and the resolution of the third image is 2560*1080. The resolution of the spliced image may be 3840*2160. In this case, the resolution corresponding to the display data of the first image in the spliced image is (2560/2)*(1080*2), that is, 1280*2160; the resolution corresponding to the display data of the second image in the spliced image is (2560/2)*(1080*2), that is, 1280*2160; and the resolution corresponding to the display data of the fourth image in the spliced image is (2560/2)*(1080*2), that is, 1280*2160. The resolution of the spliced image may be 3840*2160. In this manner, the first image, the second image, and the third image are folded. FIG. 17 is a schematic diagram of yet another display signal provided in an embodiment of the present disclosure.

Optionally, for an example of folding an image, reference may also be made to the description in the foregoing embodiments corresponding to FIG. 4 to FIG. 11. For a manner in which the transmitting unit transmits the display data, reference may also be made to the description in the foregoing embodiments, which will not be repeatedly described in detail herein.

It can be understood that, in combination with the examples described in the embodiments disclosed in the present disclosure, units and method steps may be implemented by hardware or a combination of hardware and computer software. Whether a certain function is executed by means of hardware or computer software to drive the hardware depends on a specific application scenario and a design constraint condition of a technical solution.

Reference is made to FIG. 18, which is a schematic structural diagram of an electronic device provided in an embodiment of the present disclosure. The electronic device 180 illustrated in FIG. 18 includes a sending unit 1801.

In some embodiments:

The sending unit 1801 is configured to send a display signal. The display signal includes multiple types of display sub-signals, each display sub-signal of each type of display sub-signal includes a first part and a second part, first parts of different types of display sub-signals are display data for the same display unit, and second parts of different types of display sub-signals are display data for different display units.

In some possible embodiments, a frame rate of the same display unit is greater than frame rates of different display units.

In some possible embodiments, a display sub-signal contains indication data, and the indication data indicates display units corresponding to display data contained in the display sub-signal.

In some possible embodiments, data amount of each type of display sub-signals is the same.

In some possible embodiments, display data for a display unit contained in a display sub-signal is folded display data, and a product of a fold parameter of horizontal pixels of the display data and a fold parameter of vertical pixels of the display data is 1.

In some possible embodiments, a display unit includes at least one of the following: a dashboard screen, a central control screen, an HUD screen, a front-passenger screen, a rear-seat screen, or an air conditioner screen.

In some other embodiments:

The sending unit 1801 is configured to send a display signal, the display signal contains display data for at least one display unit, where the display data for the at least one display unit is folded display data, and a product of a fold parameter of horizontal pixels of the display data and a fold parameter of vertical pixels of the display data is 1.

In some possible embodiments, the display unit includes at least one of the following: a dashboard screen, a central control screen, an HUD screen, a front-passenger screen, a rear-seat screen, or an air conditioner screen.

It is to be noted that the electronic device in embodiments of the present disclosure can execute operations related to the processing unit in method embodiments as illustrated in FIG. 12 to FIG. 17. For specific implementations, reference can be made to the implementations provided in the above operations, which will not be reiterated here.

Reference is made to FIG. 19, where FIG. 19 is a schematic structural diagram of another electronic device provided in an embodiment of the disclosure. In some embodiments, the electronic device 190 is configured to implement the functions performed by the processing unit in FIG. 2 to FIG. 17. The electronic device may be an apparatus configured to generate and send a display signal in a multi-screen display system, or an SOC or a chip in the apparatus. The SOC may be consisted of the chip, or of the chip and other discrete devices.

The electronic device 190 includes at least one processor 1920. The processor 1920 is configured to implement the data processing functions in the methods provided in embodiments of the disclosure. The electronic device 190 may further include a communication interface 1910. The communication interface 1910 is configured to implement the transceiving operations in the methods provided in embodiments of the disclosure. In embodiments of the disclosure, the communication interface may be a transceiver, a circuit, a bus, a module, or another type of communication interface, for communicating with other devices via a transmission medium. For example, the communication interface 1910 is configured to perform communication between an apparatus in the electronic device 190 and another device. The processor 1920 is configured to transmit and receive data via the communication interface 1910, and to implement the methods illustrated in FIG. 2 to FIG. 17 in the method embodiments above.

The electronic device 190 may further include at least one memory 1930. The memory 1930 is configured to store program instructions and/or data. The memory 1930 is coupled with the processor 1920. The coupling in embodiments of the disclosure may be an indirect coupling or communication connection between apparatuses, units, or modules, and may be in electrical, mechanical or other forms, for information interaction among the apparatuses, the units, or the modules. The processor 1920 may perform operations in cooperation with the memory 1930. The processor 1920 may be configured to execute program instructions stored in the memory 1930. At least one of the at least one memory may be included in the processor.

In embodiments of the disclosure, a specific connection medium among the communication interface 1910, the processor 1920, and the memory 1930 is not limited. In embodiments of the disclosure, the memory 1930, the processor 1920, and the communication interface 1910 are connected through a bus 2440 in FIG. 19, where the bus is represented by a thick line in FIG. 19, and a connection manner between other components is only for illustrative descriptions and is not limited thereto. The bus may be classified into an address bus, a data bus, a control bus, and the like. For the convenience of representation, only one thick line is illustrated in FIG. 19, which, however, does not mean that there is only one bus or one type of bus.

In embodiments of the present disclosure, the processor may be a general-purpose processor, a digital signal processor (DSP), an application specific integrated circuit (ASIC), a field programmable gate array (FPGA), or other programmable logic devices, discrete gates or transistor logic devices, discrete hardware components, which can be configured to execute or implement the methods, operations, and logic blocks disclosed in embodiments of the present disclosure. The general-purpose processor may be a microprocessor or any conventional processor or the like. The operations of the method disclosed in embodiments may be directly implemented as a hardware processor, or may be performed by hardware and software modules in the processor.

It is to be noted that, the electronic device 190 may execute related operations of the processing unit in the foregoing method embodiments. For details, reference can be made to the embodiments provided in the foregoing operations, which will not be repeated herein.

For each apparatus and product applied to or integrated into the communication apparatus, each module included can be implemented by hardware such as circuits, and different modules can be located in a same component (such as a chip, a circuit module, and the like) or different components in user equipment (UE), or at least part of modules can be implemented by software programs that run on the processor integrated into the UE, and the rest (if any) of modules can be implemented by hardware such as circuits.

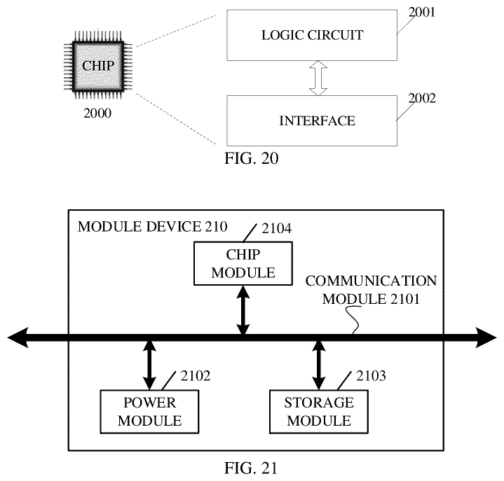

For a case in which the electronic device may be a chip or an SOC, reference may be made to a schematic structural diagram of a chip illustrated in FIG. 20. Reference is made to FIG. 20, which is a schematic structural diagram of a chip provided in an embodiment of the present disclosure. The chip 2000 includes a logic circuit 2001 and an interface 2002. The number of the logic circuit 2001 may be one or more, and the number of the interfaces 2002 may be more than one.

In an embodiment, the logic circuit 2001 is configured to send a display signal. The display signal includes multiple types of display sub-signals, each display sub-signal of each type of display sub-signal includes a first part and a second part, first parts of different types of display sub-signals are display data for the same display unit, and second parts of different types of display sub-signals are display data for different display units.

In another embodiment, the logic circuit 2001 is configured to send a display signal. the display signal includes display data for at least one display unit, the display data for the at least one display unit is folded display data, and a product of a fold parameter of horizontal pixels of the display data and a fold parameter of vertical pixels of the display data is 1.

It is to be noted that, the chip or SOC may execute related operations of the processing unit in the foregoing method embodiments. For details, reference can be made to the embodiments provided in the foregoing operations, which will not be repeated herein.

FIG. 21 is a schematic structural diagram of a module device provided in an embodiment of the disclosure. The module device 210 includes a communication module 2101, a power module 2102, a storage module 2103, and a chip module 2104. The power module 2102 is configured to supply power to the module device 210. The storage module 2103 is configured to store data and an instruction. The communication module 2101 is configured to perform communication in the module device, or configured to perform communication between the module device and an external device.

In an embodiment, the chip module 2104 is configured to send a display signal. The display signal includes multiple types of display sub-signals, each display sub-signal of each type of display sub-signal includes a first part and a second part, first parts of different types of display sub-signals are display data for the same display unit, and second parts of different types of display sub-signals are display data for different display units.

In another embodiment, the chip module 2104 is configured to send a display signal. The display signal includes display data for at least one display unit, the display data for the at least one display unit is folded display data, and a product of a fold parameter of horizontal pixels of the display data and a fold parameter of vertical pixels of the display data is 1.

It is to be noted that, the module device 210 may execute related operations of the processing unit in the foregoing method embodiments. For details, reference can be made to the embodiments provided in the foregoing operations, which will not be repeated herein.

A non-transitory computer-readable storage medium is further provided in embodiments of the disclosure. The non-transitory computer-readable storage medium stores a computer-readable instruction which, when executed by a computer, causes the computer to execute the method procedures in the foregoing method embodiments.

A computer program product is further provided in embodiments of the disclosure, which, when executed by a processor, are operable with the processor to implement the method procedures in the foregoing method embodiments.

For each module/unit/unit included in an apparatus or a product described in the embodiments above, each module/unit/unit may be a software module/unit, a hardware module/unit, or may be partially a software module/unit and partially a hardware module/unit. For example, for each apparatus and product applied to or integrated into the chip, each module/unit included can be implemented by hardware such as circuits, or at least part of modules/units can be implemented by software programs that run on a processor integrated into the chip, and the rest (if any) of modules/units can be implemented by hardware such as circuits. For each apparatus and product applied to or integrated into the chip module/unit, each module/unit included can be implemented by hardware such as circuit, and different module/units can be located in the same component (such as a chip, a circuit module/unit, and the like) or different components of the chip module. Alternatively, at least part of module/units can be implemented by software programs that run on the processor integrated into the chip module/unit, and the rest (if any) of module/units can be implemented by hardware such as circuits. For each apparatus and product applied to or integrated into the UE, each module/unit included can be implemented by hardware such as circuits, and different module/units can be located in the same component (such as a chip, a circuit module/unit, and the like) or different components in the UE, or at least part of module/units can be implemented by software programs that run on the processor integrated into the UE, and the rest (if any) of modules/units can be implemented by hardware such as circuits.

It is to be noted that, for the sake of simplicity, the foregoing method embodiments are described as a series of action combinations. However, it will be appreciated by those skilled in the art that embodiments are not limited by the sequence of actions described. According to embodiments, some steps or operations may be performed in other orders or simultaneously. Besides, it will be appreciated by those skilled in the art that the embodiments described in the specification are exemplary embodiments, and the actions and modules involved are not necessarily essential to the disclosure.

In the foregoing embodiments, the description of each embodiment can refer to each other, and the description of each embodiment has its own emphasis. For the parts not described in detail in one embodiment, reference can be made to related descriptions in other embodiments. For the sake of convenience and simplicity, for example, in terms of the functions and operations of each apparatus and device in embodiments of the disclosure, reference can be made to the related descriptions of the method embodiments, and reference or citation can also be made to each other between the method embodiments and between the apparatus embodiments.

Finally, it is to be noted that, the foregoing embodiments are only for the purpose of illustrating the technical solutions rather than limiting the disclosure. Although the disclosure is described in detail with reference to the foregoing embodiments, it will be understood by those of ordinary skill in the art that modifications can be made to the technical solutions described in the foregoing embodiments, or that equivalent arrangements can be made to some or all technical features thereof. In terms of the essence of the corresponding technical solutions, these modifications or equivalent arrangements shall also fall within the scope of protection of the technical solutions of embodiments of the disclosure.

1. A transmission method for display data, comprising:
sending a display signal, wherein the display signal comprises a plurality of types of display sub-signals, each display sub-signal of each type of display sub-signal comprises a first part and a second part, first parts of different types of display sub-signals are display data for the same display unit, and second parts of different types of display sub-signals are display data for different display units.

2. The method of claim 1, wherein a frame rate of the same display unit is greater than frame rates of different display units.

3. The method of claim 1, wherein a display sub-signal contains indication data, and the indication data indicates display units corresponding to display data contained in the display sub-signal.

4. The method of claim 1, wherein data amount of each type of display sub-signals is the same.

5. The method of claim 1, wherein display data for a display unit contained in a display sub-signal is folded display data, and a product of a fold parameter of horizontal pixels of the display data and a fold parameter of vertical pixels of the display data is 1.

6. The method of claim 1, wherein a display unit comprises at least one of the following:
a dashboard screen, a central control screen, a head-up display (HUD) screen, a front-passenger screen, a rear-seat screen, or an air conditioner screen.

7. The method of claim 1, wherein the display signal comprises a first type of display sub-signals, a first part of the first type of display sub-signals is display data of a first image, and a second part of a second type of display sub-signals is display data of a second image, the first part and the second part of the first type of display sub-signals are spliced to form a first spliced image, and a number of pixels of the first spliced image is greater than or equal to a sum of a number of pixels of the first image and a number of pixels of the second image.

8. The method of claim 7, wherein in response to the number of pixels of the first spliced image being greater than the sum of the number of pixels of the first image and the number of pixels of the second image, pixels of the first spliced image further comprise padding pixels.

9. The method of claim 1, wherein sending frequencies of the plurality of types of display sub-signals are determined based on a frame-rate requirement of a display unit.

10. The method of claim 3, wherein the indication information is located at a head, a partial head, or tail of the display sub-signal.

11. A transmission method for display data, comprising:
sending a display signal, wherein the display signal contains display data for at least one display unit, the display data for the at least one display unit is folded display data, and a product of a fold parameter of horizontal pixels of the display data and a fold parameter of vertical pixels of the display data is 1.

12. The method of claim 11, wherein the display unit comprises at least one of the following:
a dashboard screen, a central control screen, a head-up display (HUD) screen, a front-passenger screen, a rear-seat screen, or an air conditioner screen.

13. The method of claim 11, wherein the display signal contains display data of a first image for a first display unit and display data of a second image for a second display unit, the display data of the first image and the display data of the second image are spliced to form a spliced image, and a number of pixels of the spliced image is greater than or equal to a sum of a number of pixels of the first image and a number of pixels of the second image.

14. The method of claim 13, wherein in response to the number of pixels of the spliced image being greater than the sum of the number of pixels of the first image and the number of pixels of the second image, pixels of the spliced image further comprise padding pixels.

15. (canceled)

16. An electronic device, comprising a processor and a memory, wherein the memory is configured to store a computer program, and the processor is configured to invoke the computer program from the memory to make the electronic device execute:
sending a display signal, wherein the display signal comprises a plurality of types of display sub-signals, each display sub-signal of each type of display sub-signal comprises a first part and a second part, first parts of different types of display sub-signals are display data for the same display unit, and second parts of different types of display sub-signals are display data for different display units.

17-20. (canceled)

21. The electronic device of claim 16, wherein a frame rate of the same display unit is greater than frame rates of different display units.

22. The electronic device of claim 16, wherein a display sub-signal contains indication data, and the indication data indicates display units corresponding to display data contained in the display sub-signal.

23. The electronic device of claim 16, wherein data amount of each type of display sub-signals is the same.

24. The electronic device of claim 16, wherein display data for a display unit contained in a display sub-signal is folded display data, and a product of a fold parameter of horizontal pixels of the display data and a fold parameter of vertical pixels of the display data is 1.

25. The electronic device of claim 16, wherein the display signal comprises a first type of display sub-signals, a first part of the first type of display sub-signals is display data of a first image, and a second part of a second type of display sub-signals is display data of a second image, the first part and the second part of the first type of display sub-signals are spliced to form a first spliced image, and a number of pixels of the first spliced image is greater than or equal to a sum of a number of pixels of the first image and a number of pixels of the second image.
